(19) United States
(12) Patent Application Publication
(10) Pub. No.: US 2021/0105826 A1
(43) Pub. Date: Apr. 8, 2021

(54) METHOD AND APPARATUS FOR RANDOM ACCESS IN COMMUNICATION SYSTEM

(71) Applicant: ELECTRONICS AND TELECOMMUNICATIONS RESEARCH INSTITUTE, Daejeon (KR)

(72) Inventors: Ji Soo PARK, Daejeon (KR); Il Gyu KIM, Chungcheongbuk-do (KR); Nam Suk LEE, Daejeon (KR)

(21) Appl. No.: 17/029,740

(22) Filed: Sep. 23, 2020

(30) Foreign Application Priority Data
Oct. 4, 2019 (KR) 10-2019-0122896

(51) Int. Cl. H04W 74/08; H04W 74/00

(52) U.S. Cl. CPC H04W 74/0833; H04W 74/006

(57) ABSTRACT

A random access method, performed by a first terminal in a communication system, includes receiving, from a base station, PRACH configuration information including information on RA resource(s) used for transmission and reception of RA preamble(s) and RAR configuration information used for transmission and reception of RAR(s); transmitting a first RA preamble to the base station based on the information on the RA resource(s); when the first RA preamble is transmitted, performing a monitoring operation for receiving a first RAR that is a response to the first RA preamble; and selecting the first RAR for the first terminal from one or multiple RARs using the RAR configuration information in the monitoring operation.

### CROSS-REFERENCE TO RELATED APPLICATION

This application claims priority to Korean Patent Application No. 10-2019-0122896 filed on Oct. 4, 2019 with the Korean Intellectual Property Office (KIPO), the entire content of which is hereby incorporated by reference.

### BACKGROUND

### 1. Technical Field

The present disclosure relates to a technique for random access in a communication system, and more specifically, to a random access technique for processing random access requests of a plurality of terminals.

### 2. Description of Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

The communication system (hereinafter, a new radio (NR) communication system) using a higher frequency band (e.g., a frequency band of 6 GHz or above) than a frequency band (e.g., a frequency band of 6 GHz or below) of the long term evolution (LTE) (or, LTE-A) is being considered for processing of soaring wireless data. The 5G communication system can support enhanced mobile broadband (eMBB), ultra-reliable low-latency communication (URLLC), massive machine type communication (mMTC), and the like.

In the communication system (e.g., 4G communication system or 5G communication system), a random access procedure may be performed for synchronization acquisition, power control, uplink resource request, and/or handover. In the random access procedure, a terminal may transmit a random access (RA) preamble to a base station through a physical random access channel (PRACH). In particular, a plurality of terminals may transmit the same RA preambles to the base station through the same PRACH. In this case, the base station may transmit one random access response (RAR) to the terminals in response to the RA preambles. Therefore, even though a plurality of terminals attempt random access, only a random access procedure for one terminal can be performed.

### SUMMARY

Accordingly, exemplary embodiments of the present disclosure are directed to providing methods and apparatuses for processing random access requests of a plurality of terminals in a communication system.

According to a first exemplary embodiment of the present disclosure, a random access method, performed by a first terminal in a communication system, may comprise receiving, from a base station, physical random access channel (PRACH) configuration information including information on random access (RA) resource(s) used for transmission and reception of RA preamble(s) and random access response (RAR) configuration information used for transmission and reception of RAR(s); transmitting a first RA preamble to the base station based on the information on the RA resource(s); when the first RA preamble is transmitted, performing a monitoring operation for receiving a first RAR that is a response to the first RA preamble; and selecting the first RAR for the first terminal from one or multiple RARs using the RAR configuration information in the monitoring operation.

The information on RA resource(s) may include information indicating location(s) of resource(s) used for transmission and reception of the RA preamble(s) and information indicating a preamble set composed of RA preamble sequences.

The RAR configuration information may include at least one of information indicating a selection criterion for the first RAR among the one or multiple RARs and information indicating a number of the one or multiple RARs.

The information indicating the selection criterion for the first RAR may include at least one of RAR group configuration information, RAR group indication information, RAR transmission pattern information expressed in a time domain, information on a number of RARs, RAR sequence number information, configuration information of response data unit(s) included in an RAR, and information indicating a response data unit to be selected when a plurality of response data units are included in an RAR.

The first RAR selected from among the one or multiple RARs including a preamble indicator for identifying a sequence of the first RA preamble transmitted by the first terminal may be indicated by the RAR configuration information.

The first RAR selected from among the multiple RARs including an RA preamble indicator identical to an RA preamble indicator for identifying a sequence of the first RA preamble may be randomly selected from among the multiple RARs.

The one or multiple RARs may be identified by a random access-radio network temporary identifier (RA-RNTI) identical to a first RA-RNTI generated based on a location of a time-frequency resource in which the first RA preamble used by the first terminal is transmitted.

Each of the one or multiple RARs may include resource allocation information for an RA MSG #3 and an RA preamble indicator for identifying an RA preamble sequence.

When the first RAR selected by the first terminal is composed of a plurality of response data units each of which includes an RA preamble indicator identical to an RA preamble indicator for identifying a sequence of the first RA preamble transmitted by the first terminal and resource allocation information for an RA MSG #3, a response data unit indicated by the RAR configuration information may be selected, or one response data unit may be randomly selected among the plurality of response data units or response data units indicated by the RAR configuration information.

According to a second exemplary embodiment of the present disclosure, a random access method, performed by a base station in a communication system, may comprise transmitting, to a terminal, physical random access channel (PRACH) configuration information including information on random access (RA) resource(s) used for transmission and reception of RA preamble(s) and random access response (RAR) configuration information used for transmission and reception of RAR(s); detecting an RA preamble transmitted from one or more terminals by performing a monitoring operation in an RA resource indicated by the information on the RA resource(s); generating one or multiple RARs for the one or more terminals by using the RAR configuration information to respond to the detected RA preamble; and transmitting the one or multiple RARs to the one or more terminals.

The information on RA resource(s) may include information indicating location(s) of resource(s) used for transmission and reception of RA preamble(s) and information indicating a preamble set composed of RA preamble sequences.

The RAR configuration information may include at least one of information indicating a selection criterion for the first RAR among the one or multiple RARs and information indicating a number of the one or multiple RARs.

The information indicating the selection criterion for the first RAR may include at least one of RAR group configuration information, RAR group indication information, RAR transmission pattern information expressed in a time domain, information on a number of RARs, RAR sequence number information, configuration information of response data unit(s) included in an RAR, and information indicating a response data unit to be selected when a plurality of response data units are included in an RAR.

Each of the one or multiple RARs for the detected RA preamble may include resource allocation information for RA MSG #3 and an RA preamble indicator identical to an RA preamble indicator for identifying a sequence of the detected RA preamble, and the resource allocation information included in the one or multiple RARs may indicate different time-frequency resources.

One or more RARs among the one or multiple RARs for the detected RA preamble may include a plurality of response data units, each of the plurality of response data units may include resource allocation information for RA MSG #3 and an RA preamble indicator identical to an RA preamble indicator for identifying a sequence of the detected RA preamble, and the resource allocation information included in the plurality of response data units may indicate different time-frequency resources.

According to a third exemplary embodiment of the present disclosure, a random access method, performed by a base station in a communication system, may comprise transmitting physical random access channel (PRACH) configuration information shared by a plurality of terminals performing a contention-free random access procedure; performing a monitoring operation for receiving a random access (RA) preamble in a radio resource indicated by the PRACH configuration information; generating different random access responses (RARs) for the plurality of terminals when the RA preamble is detected in the radio resource; and transmitting the different RARs to the plurality of terminals.

The PRACH configuration information may include information indicating a PRACH used by the plurality of terminals and information indicating an RA preamble sequence used by the plurality of terminals.

A plurality of RA preambles generated by the plurality of terminals may have a same RA preamble sequence indicated by the PRACH configuration information, and the plurality of RA preambles may be transmitted through a same PRACH indicated by the PRACH configuration information.

Information indicating the plurality of terminals sharing the PRACH configuration information may be transmitted from the base station to the plurality of terminals.

Even when the RA preambles of one or more terminals among the plurality of terminals are not transmitted, the different RARs for the plurality of terminals may be transmitted from the base station.

According to the exemplary embodiments of the present disclosure, the base station may transmit an RAR including a plurality of resource allocation information for random access (RA) message (MSG) #3 transmission to terminals. Each of the terminals may transmit an RA MSG #3 to the base station by using one resource allocation information among one or more resource allocation information included in the RAR. Accordingly, a success probability of the random access procedure can be improved by distributing and increasing contention opportunities by the RA MSG #3 without increasing RA resources (e.g., physical random access channel (PRACH) resources, RA preamble sequences). As a result, the reliability and performance of the communication system can be improved.

### BRIEF DESCRIPTION OF DRAWINGS

Exemplary embodiments of the present disclosure will become more apparent by describing in detail embodiments of the present disclosure with reference to the accompanying drawings, in which:

FIG. 1 is a conceptual diagram illustrating a first exemplary embodiment of a communication system;

FIG. 2 is a block diagram illustrating a first exemplary embodiment of a communication node constituting a communication system;

FIG. 3 is a conceptual diagram illustrating a first exemplary embodiment of an RA preamble sequence in a communication system;

FIG. 4 is a conceptual diagram illustrating a first exemplary embodiment of a PRACH in a communication system;

FIG. 5 is a sequence chart illustrating a first exemplary embodiment of a CBRA procedure in a communication system;

FIG. 6 is a sequence chart illustrating a first exemplary embodiment of a CFRA procedure in a communication system;

FIG. 7 is a sequence chart illustrating a second exemplary embodiment of a CBRA procedure in a communication system;

FIG. 8 is a sequence chart illustrating a second exemplary embodiment of a CFRA procedure in a communication system;

FIG. 9 is a sequence chart illustrating a third exemplary embodiment of a CBRA procedure in a communication system;

FIG. 10 is a sequence chart illustrating a first exemplary embodiment of an RAR transmission method in a communication system;

FIG. 11 is a sequence chart illustrating a second exemplary embodiment of an RAR transmission method in a communication system;

FIG. 12 is a sequence chart illustrating a third exemplary embodiment of an RAR transmission method in a communication system;

FIG. 13 is a conceptual diagram illustrating a first exemplary embodiment of a random access procedure between a base station and a plurality of terminals in a communication system; and

FIG. 14 is a timing diagram illustrating a first exemplary embodiment of a random access procedure between a base station and a plurality of terminals in a communication system.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be a 4G communication network (e.g., a long-term evolution (LTE) communication system or an LTE-advanced (LTE-A) communication system), a 5G communication network (e.g., a new radio (NR) communication system), or the like. The 4G communication system may support communication in a frequency band of 6 GHz or below. The 5G communication system may support communication in a frequency band of 6 GHz or above, as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network. The ‘LTE’ may refer to the 4G communication system, LTE communication system, or LTE-A communication system, and the ‘NR’ may refer to the 5G communication system or NR communication system.

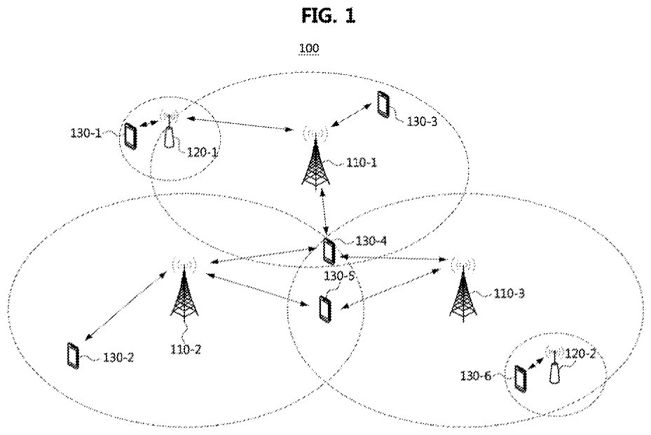

FIG. 1 is a conceptual diagram illustrating a first exemplary embodiment of a communication system.

Referring to FIG. 1, a communication system 100 may include a plurality of communication nodes 110-1, 110-2, 110-3, 120-1, 120-2, 130-1, 130-2, 130-3, 130-4, 130-5, and 130-6. In addition, the communication system 100 may further include a core network (e.g., serving-gateway (S-GW), packet data network (PDN)-gateway (P-GW), and mobility management entity (MME)). When the communication system 100 is the 5G communication system (e.g., NR system), the core network may include an access and mobility management function (AMF), a user plane function (UPF), a session management function (SMF), and the like.

The plurality of communication nodes 110 to 130 may support the communication protocols (e.g., LTE communication protocol, LTE-A communication protocol, NR communication protocol, etc.) defined by technical specifications of 3rd generation partnership project (3GPP). The plurality of communication nodes 110 to 130 may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

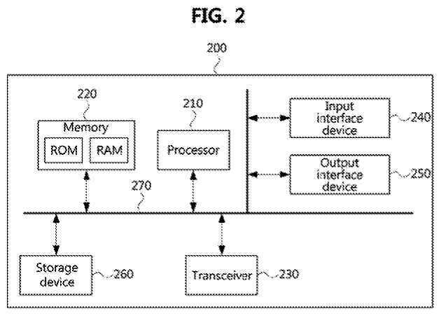

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, an evolved Node-B (eNB), an advanced base station (BTS), a high reliability-base station (HR-BS), a base transceiver station (BTS), a radio base station, a radio transceiver, an access point, an access node, a radio access station (RAS), a mobile multi-hop relay base station (MMR-BS), a relay station (RS), an advanced relay station (ARS), a high reliability-relay station (HR-RS), a home NodeB (HNB), a home eNodeB (HeNB), a roadside unit (RSU), a radio remote head (RRH), a transmission point (TP), a transmission and reception point (TRP), a macro cell, a pico cell, a micro cell, a femto cell, or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on board unit (OBU), or the like.

The base station and the terminal may perform communication using an omnidirectional beam, a sector beam, or a spot beam. The omni-directional beam may be formed using an omni-directional antenna, and the spot beam may be formed using a beamforming antenna.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the communication system (e.g., 4G communication system or 5G communication system), a random access procedure may be performed for synchronization acquisition, power control, uplink resource request, and/or handover. The random access (RA) resources may include a physical random access channel (PRACH) transmission occasion slot(s) (RAO(s)) used for transmission and reception of an RA preamble and an RA preamble index(es) (i.e., RAPIdx(es)) used to distinguish the RA preamble. The RA preamble may be configured with a sequence having autocorrelation characteristics. The random access procedure between the base station and the terminal may be distinguished by the RA resources (e.g., RAO and RAPIdx).

The RAO may be a time-frequency resource for transmission and reception of an RA preamble. The length of the RAO in the time domain may vary according to a subcarrier spacing, preamble format, and the like. For example, the length of the RAO in the time domain may be the length of one or more symbols, one or more slots, or a subframe. In the frequency domain, the RAO may be composed of one or more subcarriers within a system bandwidth (e.g., bandwidth part).

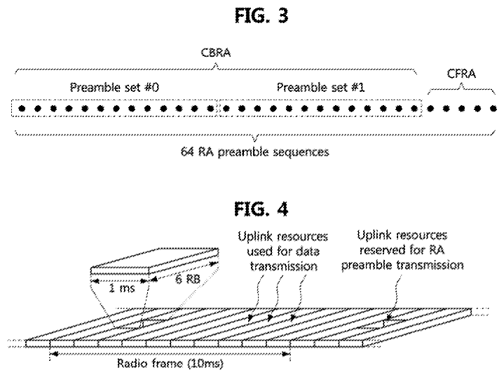

FIG. 3 is a conceptual diagram illustrating a first exemplary embodiment of an RA preamble sequence in a communication system.

Referring to FIG. 3, 64 RA preamble sequences may be configured for each cell. Among the 64 RA preamble sequences, some RA preamble sequences may be used for a contention-based random access (CBRA) procedure, and the remaining RA preamble sequences may be used for a contention-free random access (CFRA) procedure. The RA preamble sequences used for the CBRA procedure may be classified into two sets (e.g., preamble set #0 and preamble set #1). The base station may transmit configuration information of the preamble sets #0 and #1 to the terminal. The configuration information of the preamble sets #0 and #1 may be included in a radio resource control (RRC) message and/or system information.

When the CBRA procedure is performed, the terminal may randomly select one RA preamble sequence from the preamble set #0 or #1. The terminal may generate an RA preamble using the selected RA preamble sequence, and may transmit the generated RA preamble to the base station through a PRACH. The preamble set used by the terminal may be determined based on the size of data to be transmitted through an RA MSG #3 and/or a transmission power of the terminal. For example, when the size of data to be transmitted through the RA MSG #3 is greater than or equal to a threshold, the terminal may transmit an RA preamble generated by using an RA preamble sequence selected from the preamble set #0 to the base station. When the size of data to be transmitted through the RA MSG #3 is less than the threshold, the terminal may transmit an RA preamble generated by using an RA preamble sequence selected from the preamble set #1 to the base station. In this case, the base station may refer to the preamble set to which the RA preamble sequence received from the terminal belongs to determine the size of an uplink resource to be allocated to the terminal.

FIG. 4 is a conceptual diagram illustrating a first exemplary embodiment of a PRACH in a communication system.

Referring to FIG. 4, a PRACH may be composed of one or more resource blocks (e.g., 6 resource blocks) in the frequency domain. For example, the size of the PRACH in the frequency domain may be the same as the size of a minimum uplink bandwidth in which the communication system can operate. The RAO may be allocated for each subframe or slot in consideration of an access latency, a load of the random access procedure, and/or a success probability of the random access procedure. Alternatively, in order to increase the transmission opportunities of the RA preamble, a plurality of RAOs may be configured within one subframe or one slot. In this case, the plurality of RAOs may be multiplexed in the frequency domain. As the number of RAOs increases in the communication system, resources to be used for transmission of other data, information, and/or signals may decrease. Therefore, the efficiency of resource use in the communication system may decrease.

The RAO may be configured by the base station. The RAO and RAPIdx may be maintained in a reserved state for a preconfigured time regardless of whether the corresponding RA preamble is actually transmitted. Since the RAO is maintained in a reserved state even when there is no RA preamble to be transmitted, radio resources may be wasted. In addition, when the number of RA preamble sequences is increased, reception complexity may increase.

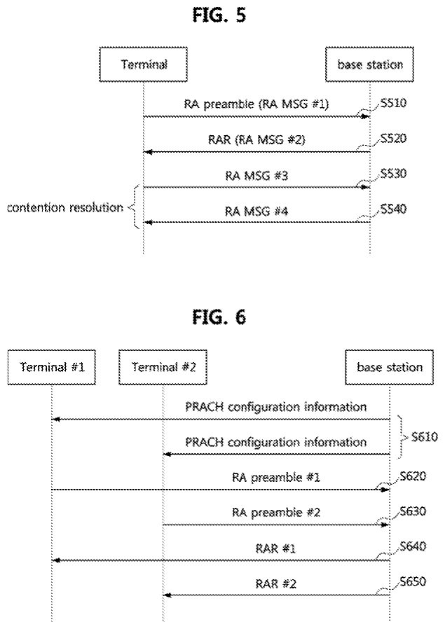

FIG. 5 is a sequence chart illustrating a first exemplary embodiment of a CBRA procedure in a communication system.

Referring to FIG. 5, a communication system may include a base station and a terminal. The base station may be the base station 110-1, 110-2, 110-3, 120-1, or 120-2 shown in FIG. 1, and the terminal may be the terminal 130-1, 130-2, 130-3, 130-4, 130-5, or 130-6 shown in FIG. 1. The base station and the terminal may be configured to be the same as or similar to the communication node 200 shown in FIG. 2.

The terminal may receive a synchronization signal (e.g., synchronization signal/physical broadcast channel (SS/PBCH) block) from the base station, and acquire downlink frame synchronization (e.g., downlink timing) based on the synchronization signal. Particularly, the synchronization signal (e.g., SS/PBCH block) may include a primary synchronization signal (PSS) and a secondary synchronization signal (SSS). In addition, the terminal may obtain PRACH configuration information from system information (e.g., system information block (SIB)) received from the base station. The PRACH configuration information may include information indicating PRACH time-frequency resources, parameters required to generate RA preambles (e.g., configuration information of the preamble sets #0 and #1), and the like. Alternatively, the PRACH configuration information may be transmitted from the base station to the terminal through another message (e.g., RRC message) instead of the system information.

When the PRACH configuration information is obtained, a random access procedure may be performed. The random access procedure may be initialized by the base station. The terminal may randomly select one RA preamble sequence within the preamble set #0 or #1. The preamble set used by the terminal may be indicated by the base station. The terminal may generate an RA preamble by using the selected RA preamble sequence, and may transmit the generated RA preamble to the base station (S510). The RA preamble may be transmitted through a PRACH (e.g., RAO) configured by the base station. The RA preamble may be referred to as ‘RA message (MSG) #1’.

The base station may receive the RA preamble by performing a monitoring operation on a PRACH (e.g., RAO). The base station may estimate a timing advance (TA) value for the corresponding terminal based on the received RA preamble. The TA value may be used to synchronize an uplink frame. The base station may generate a random access response (RAR) including the TA value and resource allocation information for transmission of an RA MSG #3, and transmit the RAR to the terminal (S520). The RAR may be referred to as ‘RA MSG #2’.

The terminal may receive the RAR from the base station and may acquire uplink frame synchronization based on the TA value included in the RAR. In case of a random access procedure performed for connecting to the communication system, the terminal may transmit an RA MSG #3 including a terminal identifier to the base station (S530). In case of a random access procedure performed after the terminal is connected to the communication system, the terminal may transmit an RA MSG #3 including an identifier (e.g., cell-radio network temporary identifier (C-RNTI)) allocated by the base station to the base station (S530).

The base station may receive the RA MSG #3 from the terminal. The base station may transmit an RA MSG #4 to the terminal in response to the RA MSG #3 (S540). The RA MSG #4 may include the identifier included in the RA MSG #3. When the RA MSG #4 is received from the base station, the terminal may determine that contention has been resolved. That is, the steps S530 and S540 may be performed for the contention resolution.

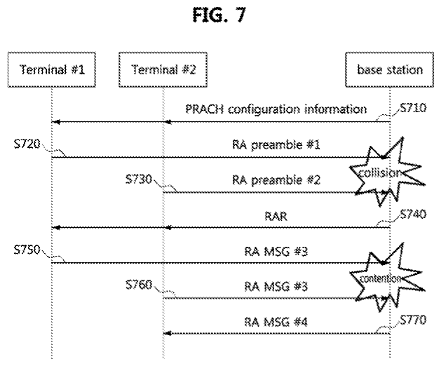

FIG. 6 is a sequence chart illustrating a first exemplary embodiment of a CFRA procedure in a communication system.

Referring to FIG. 6, a communication system may include a base station, a terminal #1, and a terminal #2. The base station may be the base station 110-1, 110-2, 110-3, 120-1, or 120-2 shown in FIG. 1, and each of the terminals #1 and #2 may be the terminal 130-1, 130-2, 130-3, 130-4, 130-5, or 130-6 shown in FIG. 1. The base station, the terminal #1, and the terminal #2 may be configured to be the same as or similar to the communication node 200 shown in FIG. 2.

The base station may transmit PRACH configuration information to the terminal #1 and the terminal #2, respectively (S610). The PRACH configuration information may indicate RA resources (e.g., RAO, RAPIdx). The RA resources for the terminal #1 may be different from the RA resources for the terminal #2. Since different RA resources are allocated to the terminals, there may be restriction on the number of terminals that can participate in the random access procedures in the communication environment in which RA resources are limited. The terminal #1 may generate an RA preamble #1 based on the PRACH configuration information obtained from the base station, and may transmit the generated RA preamble #1 to the base station through a PRACH configured by the base station (S620). The terminal #2 may generate an RA preamble #2 based on the PRACH configuration information obtained from the base station, and transmit the generated RA preamble #2 to the base station through a PRACH configured by the base station (S630).

In this case, an RA preamble sequence used to generate the RA preamble may be indicated by the PRACH configuration information (e.g., RAPIdx). The RA preamble sequence used to generate the RA preamble #1 may be different from the RA preamble sequence used to generate the RA preamble #2. The PRACH through which the RA preamble #1 is transmitted may be different from the PRACH through which the RA preamble #2 is transmitted. Alternatively, the PRACH through which the RA preamble #1 is transmitted may be the same as the PRACH through which the RA preamble #2 is transmitted.

The base station may receive the RA preamble #1 by monitoring the PRACH configured for the terminal #1. The base station may transmit an RAR #1 to the terminal #1 in response to the RA preamble #1 (S640). When the RAR #1 is received from the base station, the terminal #1 may determine that the random access procedure has been successfully completed. The base station may receive the RA preamble #2 by monitoring the PRACH configured for the terminal #2. The base station may transmit an RAR #2 to the terminal #2 in response to the RA preamble #2 (S650). When the RAR #2 is received from the base station, the terminal #2 may determine that the random access procedure has been successfully completed. When the RAR is not received within a preconfigured time, the terminal may perform the random access procedure again.

FIG. 7 is a sequence chart illustrating a second exemplary embodiment of a CBRA procedure in a communication system.

Referring to FIG. 7, a communication system may include a base station, a terminal #1, and a terminal #2. The base station may be the base station 110-1, 110-2, 110-3, 120-1, or 120-2 shown in FIG. 1, and each of the terminals #1 and #2 may be the terminal 130-1, 130-2, 130-3, 130-4, 130-5, or 130-6 shown in FIG. 1. The base station, the terminal #1, and the terminal #2 may be configured to be the same as or similar to the communication node 200 shown in FIG. 2.

The base station may transmit PRACH configuration information to the terminal #1 and the terminal #2, respectively (S710). The PRACH configuration information may indicate RA resources (e.g., RAO, RAPIdx). The RAPIdx may indicate one of the preamble sets #0 and #1 shown in FIG. 3. The RA resources for the terminal #1 may be the same as the RA resources for the terminal #2.

The terminal #1 may generate an RA preamble #1 based on the PRACH configuration information obtained from the base station. For example, the terminal #1 may select one RA preamble sequence within the preamble set indicated by the PRACH configuration information, and generate the RA preamble #1 by using the selected RA preamble sequence. The terminal #1 may transmit the RA preamble #1 through a PRACH indicated by the PRACH configuration information (S720).

The terminal #2 may generate an RA preamble #2 based on the PRACH configuration information obtained from the base station. For example, the terminal #2 may select one RA preamble sequence within the preamble set indicated by the PRACH configuration information, and generate the RA preamble #2 by using the selected RA preamble sequence. The terminal #2 may transmit the RA preamble #2 through a PRACH indicated by the PRACH configuration information (S730).

The RA preamble sequence used to generate the RA preamble #1 may be the same as the RA preamble sequence used to generate the RA preamble #2, and the PRACH through which the RA preamble #1 is transmitted may be the same as the PRACH through which the RA preamble #2 is transmitted. In this case, the RA preamble #1 may collide with the RA preamble #2. For example, the base station may not be able to distinguish between the RA preamble #1 and the RA preamble #2. Even though a plurality of RA preambles have been transmitted from the terminals #1 and #2, the base station may determine that one RA preamble has been transmitted.

Accordingly, the base station may transmit one RAR in response to the one RA preamble (S740). The RAR may include an identifier (i.e., RAPID) of the RA preamble sequence used to generate the RA preamble, resource allocation information for RA MSG #3 transmission, and the like. The RAR may be transmitted using a random access (RA)-RNTI determined based on time-frequency resources of the PRACH (e.g., RAO) through which the RA preamble is received. The terminal #1 and the terminal #2 may perform a monitoring operation for RAR reception by using the RA-RNTI determined based on the time-frequency resources of the PRACH (e.g., RAO) through which the corresponding RA preamble is transmitted.

Each of the terminal #1 and the terminal #2 may receive the RAR from the base station. The terminal #1 may transmit an RA MSG #3 to the base station by using a resource indicated by the RAR (S750). The terminal #2 may transmit an RA MSG #3 to the base station by using the resource indicated by the RAR (S760). That is, the resource through which the RA MSG #3 of the terminal #1 is transmitted may be the same as the resource through which the RA MSG #3 of the terminal #2 is transmitted. That is, the terminal #1 and the terminal #2 may attempt to access the base station using one RAR.

The base station may receive the RA MSG #3 of the terminal #1 or the terminal #2. When the RA MSG #3 of the terminal #2 is received, the base station may generate an RA MSG #4 including the identifier (e.g., C-RNTI) of the terminal #2, and transmit the RA MSG #4 (S770). The terminal #2 may receive the RA MSG #4 from the base station. Since the identifier included in the RA MSG #4 (e.g., the C-RNTI of the terminal #2) is the same as the identifier of the terminal #2, the terminal #2 may determine that the random access procedure has been successfully completed.

The terminal #1 may receive the RA MSG #4 from the base station. Since the identifier included in the RA MSG #4 (e.g., the C-RNTI of the terminal #2) is different from the identifier of the terminal #1, the terminal #1 may determine that the random access procedure has failed. In this case, the terminal #1 may perform the random access procedure again. The terminal #1 may not know that the random access procedure has failed until the RA MSG #4 is received, and accordingly, an access latency may occur in the terminal #1.

The terminal desiring to access the base station may perform a random access procedure using RA resources. When a plurality of RA preambles generated using the same RA preamble sequence are transmitted through the same PRACH in the CFRA procedure and the CBRA procedure, success of the random access procedure according to only one RA preamble can be guaranteed, and random access procedure(s) according to the remaining RA preamble(s) may fail. That is, even when a plurality of RA preambles are transmitted through the same PRACH, the base station may transmit only one RAR in response to the plurality of RA preambles. Therefore, the success probability of the random access procedure may be reduced.

As the number of terminals performing the random access procedure increases, RA resources for the CFRA procedure may become insufficient, and accordingly, the terminal may perform the CBRA procedure instead of the CFRA procedure. In this case, the number of terminals performing the CBRA procedure increases, and accordingly, the success probability of the random access procedure may rapidly decrease. In order to improve the success probability of the random access procedure, the amount of RA resources may be increased. The RA resources may include the RAO and RAPIdx.

In order to increase the amount of RA resources, a method of increasing the number of RAOs may be considered. In this case, the number of RAOs (e.g., random access occasions) may increase in a specific time period (e.g., subframe or slot). However, since many radio resources are required for PRACHs, resource use efficiency may be degraded in the communication system.

In order to increase the amount of RA resources, a method of increasing the number of RA preamble sequences may be considered. When the number of RA preamble sequences selectable by the terminal is increased, the collision probability of the RA preambles may decrease. However, when the number of RA preamble sequences increases, reception complexity may increase in the base station that detects the RA preamble sequences, and processing time of the RA preamble sequences may increase.

When the random access procedure is performed using limited RA resources, a collision probability of RA preambles may increase as the number of terminals attempting random access increases. Accordingly, the random access procedure may be performed again due to a failure of random access, and an access latency may occur. In addition, when there are insufficient RA resources to be allocated to the terminal in the CFRA procedure, the corresponding terminal may perform the CBRA procedure instead of the CFRA procedure. In this case, since the terminal additionally performs the transmission/reception procedure of the RA MSGs #3 and #4, the execution time of the random access procedure may increase.

Meanwhile, when a beam failure is detected in the 5G communication system, a beam failure recovery (BFR) procedure may be performed. The BFR procedure may be performed through a dedicated channel (e.g., PRACH). The base station may transmit PRACH configuration information (e.g., dedicated RA resources) for the BFR procedure to the terminal. If the dedicated RA resources for the BFR procedure cannot be allocated due to lack of RA resources, the BFR procedure may be performed based on the CBRA procedure. In this case, the transmission/reception procedure of the RA MSGs #3 and #4 may be additionally performed, and accordingly, the execution time of the random access procedure may increase.

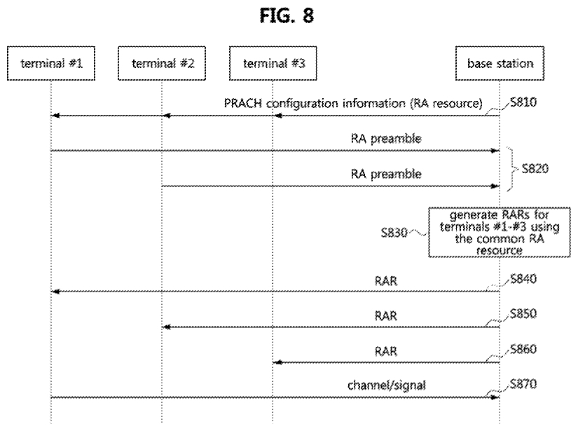

FIG. 8 is a sequence chart illustrating a second exemplary embodiment of a CFRA procedure in a communication system.

Referring to FIG. 8, a communication system may include a base station, a terminal #1, a terminal #2, and a terminal #3. The base station may be the base station 110-1, 110-2, 110-3, 120-1, or 120-2 shown in FIG. 1, and each of the terminals #1, #2, and #3 may be the terminal 130-1, 130-2, 130-3, 130-4, 130-5, or 130-6 shown in FIG. 1. The base station, the terminal #1, the terminal #2, and the terminal #3 may be configured to be the same as or similar to the communication node 200 shown in FIG. 2.

In the CFRA procedure, RA resources (e.g., RAO, RAPIdx) may be shared by a plurality of terminals (e.g., terminals #1 to #3). That is, in the CFRA procedure, the RA resources may not be configured exclusively for the terminal. The base station may configure the RA resources shared by the terminals #1 to #3 (hereinafter, referred to as ‘shared RA resources’), and may transmit PRACH configuration information indicating the shared RA resources to the terminals #1 to #3 (S810). The shared RA resources may include RAO (e.g., PRACH) and RAPIdx. The RAO configured as the shared RA resource may be shared by the terminals #1 to #3, and the RAPIdx configured as the shared RA resource may be shared by the terminals #1 to #3. In addition, the base station may transmit information indicating the terminals #1 to #3 using the shared RA resources to the terminals #1 to #3 through system information, RRC message, MAC control element (CE), and/or downlink control information (DCI).

A plurality of terminals may transmit RA preambles to the base station using the shared RA resources indicated by the PRACH configuration information. For example, when the terminals #1 to #3 are configured to use the shared RA resources, the terminals #1 to #3 may generate RA preambles using an RA preamble sequence indicated by the RAPIdx included in the shared RA resources, and transmit the RA preamble in the RAO (e.g., PRACH) indicated by the shared RA resources.

For example, among the terminals #1 to #3, the terminals #1 and #2 may need to perform the CFRA procedure, and the remaining terminal #3 may not need to perform the CFRA procedure. In this case, terminals #1 and #2 may transmit the RA preamble to the base station using the shared RA resources (S820). The remaining terminal #3 may not transmit the RA preamble to the base station. The RAO in which the RA preamble of the terminal #1 is transmitted may be the same as the RAO in which the RA preamble of the terminal #2 is transmitted. The RA preamble sequence used to generate the RA preamble of the terminal #1 may be the same as the RA preamble sequence used to generate the RA preamble of the terminal #2.

The base station may perform a monitoring operation in the RAO indicated by the shared RA resources. When an RA preamble is detected in the shared RA resources (e.g., RAO), the base station may generate RARs for all terminals (e.g., terminals #1 to #3) using the shared RA resources (S830). Even when some of the terminals #1 to #3 transmit the RA preamble using the shared RA resources, the base station may generate RARs for all the terminals (e.g., terminals #1 to #3) using the shared RA resources. The RAR #1 for the terminal #1, the RAR #2 for the terminal #2, and the RAR #3 for the terminal #3 may be generated to be distinguishable from each other. For example, the RAR #1 may include the identifier of the terminal #1, the RAR #2 may include the identifier of the terminal #2, and the RAR #3 may include the identifier of the terminal #3.

The base station may transmit the RAR #1 to the terminal #1 (S840). The base station may transmit the RAR #2 to the terminal #2 (S850). The base station may transmit the RAR #3 to the terminal #3 (S860). The RARs #1 to #3 may be transmitted using different radio resources or the same radio resources.

Only the terminal that has transmitted the RA preamble using the shared RA resources may perform a monitoring operation for RAR reception. Accordingly, the terminals #1 and #2 may perform monitoring operations for RAR reception, and the terminal #3 may not perform a monitoring operation for RAR reception. When the RAR #1 is received from the base station (e.g., when the identifier included in the RAR #1 is the same as the identifier of the terminal #1), the terminal #1 may use information included in the RAR #1 to transmit uplink data, a sounding reference signal (SRS), a hybrid automatic repeat request (HARQ) response (e.g., acknowledgement (ACK) or negative ACK (NACK)) for downlink data, and/or channel quality information to the base station (S870). The channel quality information may be transmitted through a physical uplink control channel (PUCCH).

When a channel or signal is received from the terminal based on the information included in the RAR #1, the base station may determine that the random access procedure with the terminal #1 using the shared RA resources has been successfully completed.

On the other hand, the terminal #2 may not receive the RAR #2 transmitted by the base station. In this case, the terminal #2 may determine that the random access procedure has failed, and may perform the random access procedure again. Also, since the terminal #2 cannot transmit a channel or signal to the base station based on information included in the RAR #2, the base station may not receive the channel or signal of the terminal #2. Accordingly, the base station may determine that the random access procedure with the terminal #2 has failed.

On the other hand, the terminal #3 that has not transmitted the RA preamble using the shared RA resources may not perform a monitoring operation for RAR reception. Therefore, since the RAR is not received by the terminal #3, the terminal #3 may not transmit a channel or signal to the base station based on information included in the RAR. In this case, since a channel or signal of the terminal #3 is not received by the base station, the base station may determine that the random access procedure with the terminal #3 has failed.

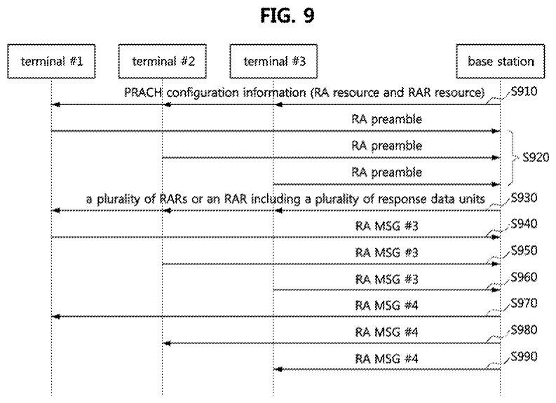

FIG. 9 is a sequence chart illustrating a third exemplary embodiment of a CBRA procedure in a communication system.

Referring to FIG. 9, a communication system may include a base station, a terminal #1, a terminal #2, and a terminal #3. The base station may be the base station 110-1, 110-2, 110-3, 120-1, or 120-2 shown in FIG. 1, and each of the terminals #1, #2, and #3 may be the terminal 130-1, 130-2, 130-3, 130-4, 130-5, or 130-6 shown in FIG. 1. The base station, the terminal #1, the terminal #2, and the terminal #3 may be configured to be the same as or similar to the communication node 200 shown in FIG. 2.

The base station may configure RA resources for the CBRA procedure. The RA resources may include RAO(s) (e.g., PRACH(s)) and RAPIdx(es) (e.g., information indicating a preamble set). In addition, the base station may configure RAR resources for the CBRA procedure. The RAR resource may include information indicating time-frequency resources through which the RAR is transmitted. In addition, when a plurality of RARs are indicated by the same RA-RNTI and include the identifier of the same RA preamble sequence, the RAR resource may include information indicating an RAR to be selected by the terminal from among the plurality of RARs. Alternatively, when one RAR includes a plurality of response data units, and the plurality of response data units are indicated by the same RA-RNTI and include the identifier of the same RA preamble sequence, the RAR resource may include information indicating a response data unit to be selected by the terminal among the plurality of response data units. Here, the RAR may be a MAC protocol data unit (PDU), and the response data unit may be a payload included in the MAC PDU.

For example, the RAR resource may include information indicating the number of RARs transmitted from the base station, an index of an RAR used by a specific terminal, information indicating the number of response data units transmitted from the base station, an index of a response data unit used by a specific terminal, and the like. The index of the RAR or response data unit used by a specific terminal may be indicated by an offset. Alternatively, the index of the RAR or response data unit used by a specific terminal may be indicated to be selected by a modulo operation.

The base station may transmit PRACH configuration information indicating the RA resources and RAR resource to the terminals (e.g., the terminals #1 to #3) (S910). The terminals #1 to #3 may receive the PRACH configuration information from the base station, and may identify the RA resources and the RAR resource indicated by the PRACH configuration information. The terminal #1 may select one RA preamble sequence from within a preamble set indicated by the RAPIdx included in the RA resources, and may generate an RA preamble using the selected RA preamble sequence. The terminal #1 may transmit the RA preamble through a RAO (e.g., PRACH) indicated by the RA resources (S920). The terminal #2 may select one RA preamble sequence from within a preamble set indicated by the RAPIdx included in the RA resources, and may generate an RA preamble using the selected RA preamble sequence. The terminal #2 may transmit the RA preamble through a RAO indicated by the RA resources (S920).

The terminal #3 may select one RA preamble sequence from within a preamble set indicated by the RAPIdx included in the RA resources, and may generate an RA preamble using the selected RA preamble sequence. The terminal #3 may transmit the RA preamble through a RAO indicated by the RA resources (S920). The RA preamble sequences selected by the terminals #1 to #3 may be the same, and the RA preambles of the terminals #1 to #3 may be transmitted through the same RAO (e.g., PRACH). In this case, the RA preambles of the terminals #1 to #3 may collide.

Meanwhile, the base station may receive the RA preamble by performing a monitoring operation in the RAO. Even when a plurality of RA preambles generated based on the same RA preamble sequence are transmitted in one RAO, the base station may determine that only one RA preamble is detected. When a plurality of terminals (e.g., the terminals #1 to #3) participate in the CBRA procedure, the base station may transmit a plurality of RARs or one RAR including a plurality of response data units to the terminals #1 to #3 (S930).

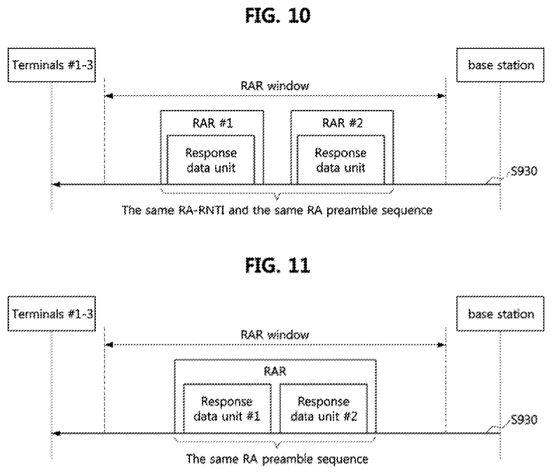

FIG. 10 is a sequence chart illustrating a first exemplary embodiment of an RAR transmission method in a communication system.

Referring to FIG. 10, each of a base station, a terminal #1, a terminal #2, and a terminal #3 shown in FIG. 10 may be the same as the base station, terminal #1, terminal #2, and terminal #3 shown in FIG. 9. The terminals #1 to #3 may generate RA preambles using the same RA preamble sequence, and may transmit the generated RA preambles through the same RAO (e.g., PRACH). In this case, the base station may transmit a plurality of RARs (e.g., RARs #1 and #2) within an RAR window. The RARs #1 and #2 may be transmitted within one RAR window.

The RAR #1 may be generated for the terminals #1 and #2, and may include one response data unit. The response data unit of the RAR #1 may include resource allocation information for RA MSG #3 transmission, identifier(s) of the RA preamble sequences (e.g., RA preamble sequences used to generate the RA preambles received from the terminals #1 to #3), and the like.

The RAR #2 may be generated for the terminal #3, and may include one response data unit. The response data unit of the RAR #2 may include resource allocation information for RA MSG #3 transmission, identifier(s) of the RA preamble sequences (e.g., RA preamble sequences used to generate the RA preambles received from the terminals #1 to #3), and the like.

The resource allocation information for RA MSG #3 transmission of each of the terminals #1 to #3 may be different. The RARs #1 and #2 may be indicated by the same RA-RNTI. For example, radio resources used for transmission of the RAR #1 and radio resources used for transmission of the RAR #2 may be indicated by DCI having the same RA-RNTI. The RA-RNTI may be determined based on time-frequency resources of the RAO (e.g., PRACH) in which the RA preambles are transmitted. The RAR #1 may be transmitted to the terminals #1 and #2, and the RAR #2 may be transmitted to the terminal #3.

FIG. 11 is a sequence chart illustrating a second exemplary embodiment of an RAR transmission method in a communication system.

Referring to FIG. 11, each of a base station, a terminal #1, a terminal #2, and a terminal #3 shown in FIG. 11 may be the same as the base station, terminal #1, terminal #2, and terminal #3 shown in FIG. 9. The terminals #1 to #3 may generate RA preambles using the same RA preamble sequence, and may transmit the generated RA preambles through the same RAO (e.g., PRACH). In this case, the base station may transmit one RAR including a plurality of response data units (e.g., response data units #1 and #2) within an RAR window. The RAR may be transmitted within one RAR window.

The response data unit #1 included in the RAR may be generated for the terminals #1 and #2. The response data unit #1 may include resource allocation information for RA MSG #3 transmission, identifiers of RA preamble sequences (e.g., identifiers of RA preamble sequences used to generate the RA preambles received from the terminals #1 to #3), and the like.

The response data unit #2 included in the RAR may be generated for the terminal #3. The response data unit #2 may include resource allocation information for RA MSG #3 transmission, identifiers of RA preamble sequences (e.g., identifiers of RA preamble sequences used to generate the RA preambles received from the terminals #1 to #3), and the like.

The resource allocation information for RA MSG #3 transmission of each of the terminals #1 to #3 may be different. The RAR may be indicated by one RA-RNTI. For example, radio resources used for transmission of the RAR may be indicated by DCI having an RA-RNTI associated with the RAO (e.g., PRACH) through which the RA preambles are transmitted. The RAR may be transmitted to the terminals #1 to #3.

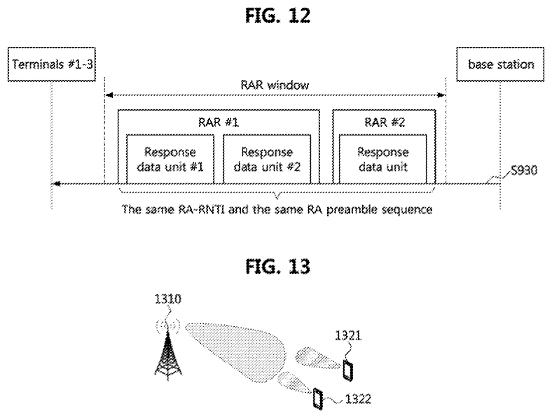

FIG. 12 is a sequence chart illustrating a third exemplary embodiment of an RAR transmission method in a communication system.

Referring to FIG. 12, each of a base station, a terminal #1, a terminal #2, and a terminal #3 shown in FIG. 12 may be the same as the base station, terminal #1, terminal #2, and terminal #3 shown in FIG. 9. The terminals #1 to #3 may generate RA preambles using the same RA preamble sequence, and may transmit the generated RA preambles through the same RAO (e.g., PRACH). In this case, the base station may transmit a plurality of RARs (e.g., RARs #1 and #2) within an RAR window. The RARs #1 and #2 may be transmitted within one RAR window.

The RAR #1 may be generated for the terminals #1 and #2, and may include a plurality of response data units (e.g., response data units #1 and #2). The response data unit #1 may be generated for the terminal #1, and the response data unit #2 may be generated for the terminal #2. The response data unit #1 may include resource allocation information for RA MSG #3 transmission, identifiers of RA preamble sequences (e.g., identifiers of RA preamble sequences used to generate the RA preambles received from the terminals #1 to #3), and the like. The response data unit #2 may include resource allocation information for RA MSG #3 transmission, identifiers of RA preamble sequences (e.g., identifiers of RA preamble sequences used to generate the RA preambles received from the terminals #1 to #3), and the like.

The RAR #2 may be generated for the terminal #3, and may include one response data unit. The response data unit of the RAR #2 may include resource allocation information for RA MSG #3 transmission, identifiers of RA preamble sequences (e.g., identifiers of RA preamble sequences used to generate the RA preambles received from the terminals #1 to #3), and the like.

The resource allocation information for RA MSG #3 transmission of each of the terminals #1 to #3 may be different. The RARs #1 and #2 may be indicated by the same RA-RNTI. For example, radio resources used for transmission of the RAR #1 and radio resources used for transmission of the RAR #2 may be indicated by DCI having the same RA-RNTI. The RA-RNTI may be determined based on time-frequency resources of the RAO (e.g., PRACH) in which the RA preambles are transmitted. The RAR #1 may be transmitted to the terminals #1 and #2, and the RAR #2 may be transmitted to the terminal #3.

Referring back to FIG. 9, the terminals #1 to #3 may receive the RARs from the base station based on the RAR resource indicated by the PRACH configuration information. In the exemplary embodiment shown in FIG. 10, the terminals #1 and #2 may receive the RAR #1, and the terminal #3 may receive the RAR #2. In the exemplary embodiment shown in FIG. 11, the terminals #1 and #2 may receive the response data unit #1 included in the RAR, and the terminal #3 may receive the response data unit #2 included in the RAR. In the exemplary embodiment shown in FIG. 12, the terminal #1 may receive the response data unit #1 included in the RAR #1, the terminal #2 may receive the response data unit #2 included in the RAR #1, and the terminal #3 may receive the response data unit included in the RAR #3.

That is, each of the terminals #1 to #3 may select one RAR indicated by the RAR resource from among a plurality of RARs. Each of the terminals #1 to #3 may select one response data unit indicated by the RAR resource from among a plurality of response data units. Alternatively, each of the terminals #1 to #3 may randomly select one RAR from among a plurality of received RARs. Each of the terminals #1 to #3 may randomly select one response data unit from among a plurality of received response data units.

The terminal #1 may transmit an RA MSG #3 to the base station based on the information included in the RAR (e.g., response data unit) (S940). The terminal #2 may transmit an RA MSG #3 to the base station based on the information included in the RAR (e.g., response data unit) (S950). The terminal #3 may transmit an RA MSG #3 to the base station based on the information included in the RAR (e.g., response data unit) (S960). In the exemplary embodiments shown FIGS. 10 and 11, the RA MSG #3 of the terminal #1 and the RA MSG #3 of the terminal #2 may be transmitted using the same radio resource.

The base station may receive the RA MSGs #3 from the terminals #1 to #3. The base station may transmit an RA MSG #4 to the terminal #1 in response to the RA MSG #3 of the terminal #1 (S970). The base station may transmit an RA MSG #4 to the terminal #2 in response to the RA MSG #3 of the terminal #2 (S980). The base station may transmit an RA MSG #4 to the terminal #3 in response to the RA MSG #3 of the terminal #3 (S990). When the RA MSG #4 is successfully received, the terminals #1 to #3 may determine that the random access procedure has been successfully completed. The terminal that has not received the RA MSG #4 may determine that the random access procedure has failed and may perform the random access procedure again.

FIG. 13 is a conceptual diagram illustrating a first exemplary embodiment of a random access procedure between a base station and a plurality of terminals in a communication system.

Referring to FIG. 13, a communication system may include a base station 1310, a terminal #1 1321, and a terminal #2 1322. The base station 1310 may be the base stations 110-1, 110-2, 110-3, 120-1, or 120-2 shown in FIG. 1, and each of the terminal #1 1321 and the terminal #2 1322 may be the terminals 130-1, 130-2, 130-3, 130-4, 130-5, or 130-6 shown in FIG. 1. The base station 1310, terminal #1 1321, and terminal #2 1322 may be configured to be the same as or similar to the communication node 200 shown in FIG. 2. The terminals #1 and #2 may generate RA preambles using the same RA preamble sequence, and may transmit the generated RA preambles to the base station through the same PRACH.

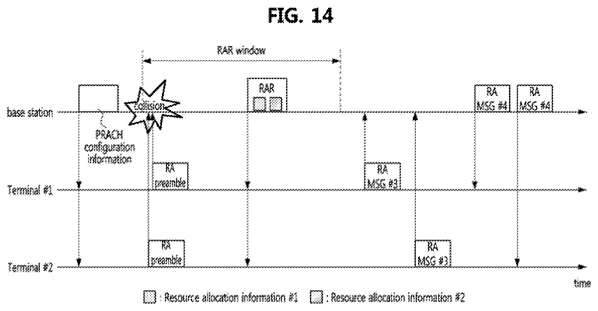

FIG. 14 is a timing diagram illustrating a first exemplary embodiment of a random access procedure between a base station and a plurality of terminals in a communication system.

Referring to FIG. 14, each of the base station, terminal #1, and terminal #2 shown in FIG. 14 may be the same as the base station, terminal #1, and terminal #2 shown in FIG. 13. The base station may transmit PRACH configuration information to terminals (e.g., terminals #1 and #2). The terminals #1 and #2 may receive the PRACH configuration information from the base station, and may transmit RA preambles to the base station based on the PRACH configuration information. For example, the terminal #1 may randomly select one RA preamble sequence from within a preamble set indicated by the PRACH configuration information, generate an RA preamble using the selected RA preamble sequence, and transmit the generated RA preamble through a PRACH indicated by the PRACH configuration information.

The terminal #2 may randomly select one RA preamble sequence from within a preamble set indicated by the PRACH configuration information, generate an RA preamble using the selected RA preamble sequence, and transmit the generated RA preamble through a PRACH indicated by the PRACH configuration information. Here, the RA preamble sequence selected by the terminal #1 may be the same as the RA preamble sequence selected by the terminal #2. The PRACH through which the RA preamble of the terminal #1 is transmitted may be the same as the PRACH through which the RA preamble of the terminal #2 is transmitted.

The base station may detect the RA preamble by performing a monitoring operation on the PRACH, and may estimate a TA value based on the detected RA preamble. The base station may generate an RAR that is a response of the RA preamble, and may transmit the generated RAR to the terminals (e.g., terminals #1 and #2). The RAR may include a plurality of resource allocation information for RA MSG #3 transmission. For example, the RAR may include resource allocation information #1 and resource allocation information #2. Time-frequency resources indicated by the resource allocation information #1 may be different from time-frequency resources indicated by the resource allocation information #2.

The terminals #1 and #2 may receive the RAR from the base station, and may adjust uplink timing using the TA value included in the RAR. When the RAR includes a plurality of resource allocation information, each of the terminals #1 and #2 may randomly select one resource allocation information from among the plurality of resource allocation information. For example, the terminal #1 may select the resource allocation information #1, and transmit an RA MSG #3 to the base station in time-frequency resources indicated by the resource allocation information #1. The terminal #2 may select the resource allocation information #2 and transmit an RA MSG #3 to the base station in time-frequency resources indicated by the resource allocation information #2.

When different resource allocation information are selected by the terminals #1 and #2, the base station may successfully receive each RA MSG #3 of the terminals #1 and #2. In this case, the base station may transmit an RA MSG #4, a response of the RA MSG #3 of the terminal #1, to the terminal #1, and transmit an RA MSG #4, a response of the RA MSG #3 of the terminal #2, to the terminal #2. The terminal #1 may receive the RA MSG #4 from the base station, and may determine that the random access procedure between the terminal #1 and the base station has been successfully completed. The terminal #2 may receive the RA MSG #4 from the base station, and may determine that the random access procedure between the terminal #2 and the base station has been successfully completed.

On the other hand, when the number of RA MSGs #3 received from the base station is less than the number of resource allocation information configured for RA MSG #3 transmission, the base station may determine that a load of the communication system (e.g., the number of participating terminals) is small. In this case, in the next random access procedure, the base station may reduce the number of resource allocation information configured for RA MSG #3 transmission.

According to the above-described exemplary embodiments, the probability of success of the random access procedure may be improved by distributing and increasing contention opportunities without increasing RA resources. Consequently, by increasing the throughput of the random access procedure, the reliability of the communication system can be improved. As the probability of success of the random access procedure is improved, a beam failure (BF) recovery procedure and a radio link failure (RLF) recovery procedure can be quickly performed. When there are many terminals in a spot beam of the base station and the TA values between the base station and the terminals are similar, the effect of the above-described exemplary embodiments can be improved.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. A random access method performed by a first terminal in a communication system, the random access method comprising:
receiving, from a base station, physical random access channel (PRACH) configuration information including information on random access (RA) resource(s) used for transmission and reception of RA preamble(s) and random access response (RAR) configuration information used for transmission and reception of RAR(s);
transmitting a first RA preamble to the base station based on the information on the RA resource(s);
when the first RA preamble is transmitted, performing a monitoring operation for receiving a first RAR that is a response to the first RA preamble; and
selecting the first RAR for the first terminal from one or multiple RARs using the RAR configuration information in the monitoring operation.

2. The random access method according to claim 1, wherein the information on RA resource(s) includes information indicating location(s) of resource(s) used for transmission and reception of the RA preamble(s) and information indicating a preamble set composed of RA preamble sequences.

3. The random access method according to claim 1, wherein the RAR configuration information includes at least one of information indicating a selection criterion for the first RAR among the one or multiple RARs and information indicating a number of the one or multiple RARs.

4. The random access method according to claim 3, wherein the information indicating the selection criterion for the first RAR includes at least one of RAR group configuration information, RAR group indication information, RAR transmission pattern information expressed in a time domain, information on a number of RARs, RAR sequence number information, configuration information of response data unit(s) included in an RAR, and information indicating a response data unit to be selected when a plurality of response data units are included in an RAR.

5. The random access method according to claim 1, wherein the first RAR selected from among the one or multiple RARs including a preamble indicator for identifying a sequence of the first RA preamble transmitted by the first terminal is indicated by the RAR configuration information.

6. The random access method according to claim 1, wherein the first RAR selected from among the multiple RARs including an RA preamble indicator identical to an RA preamble indicator for identifying a sequence of the first RA preamble is randomly selected from among the multiple RARs.

7. The random access method according to claim 1, wherein the one or multiple RARs are identified by a random access-radio network temporary identifier (RA-RNTI) identical to a first RA-RNTI generated based on a location of a time-frequency resource in which the first RA preamble used by the first terminal is transmitted.

8. The random access method according to claim 1, wherein each of the one or multiple RARs includes resource allocation information for an RA MSG #3 and an RA preamble indicator for identifying an RA preamble sequence.

9. The random access method according to claim 1, wherein when the first RAR selected by the first terminal is composed of a plurality of response data units each of which includes an RA preamble indicator identical to an RA preamble indicator for identifying a sequence of the first RA preamble transmitted by the first terminal and resource allocation information for an RA MSG #3, a response data unit indicated by the RAR configuration information is selected, or one response data unit is randomly selected among the plurality of response data units or response data units indicated by the RAR configuration information.

10. A random access method performed by a base station in a communication system, the random access method comprising:
transmitting, to a terminal, physical random access channel (PRACH) configuration information including information on random access (RA) resource(s) used for transmission and reception of RA preamble(s) and random access response (RAR) configuration information used for transmission and reception of RAR(s);
detecting an RA preamble transmitted from one or more terminals by performing a monitoring operation in an RA resource indicated by the information on the RA resource(s);
generating one or multiple RARs for the one or more terminals by using the RAR configuration information to respond to the detected RA preamble; and
transmitting the one or multiple RARs to the one or more terminals.

11. The random access method according to claim 10, wherein the information on RA resource(s) includes information indicating location(s) of resource(s) used for transmission and reception of RA preamble(s) and information indicating a preamble set composed of RA preamble sequences.

12. The random access method according to claim 10, wherein the RAR configuration information includes at least one of information indicating a selection criterion for the first RAR among the one or multiple RARs and information indicating a number of the one or multiple RARs.

13. The random access method according to claim 10, wherein the information indicating the selection criterion for the first RAR includes at least one of RAR group configuration information, RAR group indication information, RAR transmission pattern information expressed in a time domain, information on a number of RARs, RAR sequence number information, configuration information of response data unit(s) included in an RAR, and information indicating a response data unit to be selected when a plurality of response data units are included in an RAR.

14. The random access method according to claim 10, wherein each of the one or multiple RARs for the detected RA preamble includes resource allocation information for RA MSG #3 and an RA preamble indicator identical to an RA preamble indicator for identifying a sequence of the detected RA preamble, and the resource allocation information included in the one or multiple RARs indicate different time-frequency resources.

15. The random access method according to claim 10, wherein one or more RARs among the one or multiple RARs for the detected RA preamble include a plurality of response data units, each of the plurality of response data units includes resource allocation information for RA MSG #3 and an RA preamble indicator identical to an RA preamble indicator for identifying a sequence of the detected RA preamble, and the resource allocation information included in the plurality of response data units indicate different time-frequency resources.

16. A random access method performed by a base station in a communication system, the random access method comprising:
transmitting physical random access channel (PRACH) configuration information shared by a plurality of terminals performing a contention-free random access procedure;
performing a monitoring operation for receiving a random access (RA) preamble in a radio resource indicated by the PRACH configuration information;
generating different random access responses (RARs) for the plurality of terminals when the RA preamble is detected in the radio resource; and
transmitting the different RARs to the plurality of terminals.

17. The random access method according to claim 16, wherein the PRACH configuration information includes information indicating a PRACH used by the plurality of terminals and information indicating an RA preamble sequence used by the plurality of terminals.

18. The random access method according to claim 16, wherein a plurality of RA preambles generated by the plurality of terminals have a same RA preamble sequence indicated by the PRACH configuration information, and the plurality of RA preambles are transmitted through a same PRACH indicated by the PRACH configuration information.

19. The random access method according to claim 16, wherein information indicating the plurality of terminals sharing the PRACH configuration information is transmitted from the base station to the plurality of terminals.

20. The random access method according to claim 16, wherein even when the RA preambles of one or more terminals among the plurality of terminals are not transmitted, the different RARs for the plurality of terminals are transmitted from the base station.
